(19) United States
(12) Patent Application Publication
(10) Pub. No.: US 2010/0055331 A1
(43) Pub. Date: Mar. 4, 2010

(54) Organically formulated wax and method of application

(76) Inventor: Arthur Marin, North Bergen, NJ (US)

Correspondence Address: The Law Office of Stacey H. Wolfe, 84 Compass Ave, Beachwood, NJ, 08722, US

(21) Appl. No.: 12/231,103

(22) Filed: Aug. 29, 2008

(51) Int. Cl. B05D 3/12; C08L 1/00

(52) U.S. Cl. 427/355; 106/5

(57) ABSTRACT

A method and apparatus for making and applying an organic wax for protecting surfaces. The method includes steps for creating the invention as well as using the invention. Application of the invention to the surface includes applying the wax to the hands allowing the wax to melt before applying the wax to the surface. The wax is applied in a horizontal motion and then leveled with a foam and or cotton cloth. The wax is then allowed to dry and after 15 minutes the coated surface is buffed with a clean cloth to a lustrous shine. After a curing period the treated surface is wiped with a clean cloth.

### BACKGROUND OF THE INVENTION

1. Field of the Invention

The present invention relates to an organically formulated wax. More specifically the invention is directed to a hydrocarbon free non-poisonous high sheen wax that is especially useful in protecting automobile surfaces.

2. Description of Related Art

Wax comes in many forms such as cream, paste, and liquid. Many waxes contain carnauba which contains a high amount of fatty acids. This fatty acid creates a solid layer between the surface or paint and the outside world which protects it, and gives it a glossy finish. Almost all commercially available automobile waxes contain petroleum and/or other inorganic chemicals in one form or another that over time can be harmful to the painted surfaces of automobiles and other vehicles. These inorganic chemicals are added to waxes for a huge variety of reasons including making the wax more pliable and inhibiting the growth of bacteria.

Chemically, natural wax is a type of lipid that may contain a wide variety of long-chain alkanes, esters, polyesters and hydroxy esters of long-chain primary alcohols and fatty acids. They are usually distinguished from fats by the lack of triglyceride esters of glycerin (propan-1,2,3-triol) and three fatty acids. In addition to the esters that contribute to the high melting point and hardness of carnauba wax, the epicuticular waxes of plants are mixtures of substituted long-chain aliphatic hydrocarbons, containing alkanes, fatty acids, primary and secondary alcohols, diols, ketones, aldehydes. Paraffin waxes are hydrocarbons, mixtures of alkanes usually in a homologous series of chain lengths.

Carnauba is a wax derived from the leaves of the carnauba palm (Copernicia prunifera), a plant native to northeastern Brazil. It is known as “queen of waxes” and usually comes in the form of hard yellow-brown flakes. It is obtained from the leaves of the carnauba palm by collecting them, beating them to loosen the wax, then refining and bleaching the wax. Carnauba wax can produce a glossy finish and as such is used in automobile waxes, shoe polishes, food products such as candy corn, instrument polishes, and floor and furniture polishes, especially when mixed with beeswax. It is used as a coating on dental floss. Use for paper coatings is the most common application in the United States. It is the main ingredient in surfboard wax, combined with coconut oil. Carnauba wax is a prominent ingredient in cosmetics formulas: lipsticks, eyeliners, mascara, eye shadows, foundations, blushers, skin care preparations, sun care preparations, etc.

A temperature of 172 degrees Fahrenheit (78 degrees Celsius) is required to melt carnauba wax. It is also not readily soluble. Water cannot break down a layer of carnauba wax, and only certain solvents can, usually in combination with heat. This means that carnauba wax is highly durable. Used alone, the wax can waterproof fabric as well as improving and extending the fabrics wear characteristics. Combined with things such as tints and dyes, carnauba wax can be used to create an enduring colored polish. Eventually, hard wear will strip carnauba wax from most surfaces, but a fresh layer can be reapplied.

Another category of waxes are the totally synthetic waxes. These waxes commonly mix low amounts of cleaners with high amounts of U.V. inhibitors to create a protective layer similar to carnauba wax. Synthetic wax attempts to create a high gloss while carnauba waxes give a warm and wet looking finish. Manufacturers often mix carnauba wax with synthetic wax in an attempt to create a blend which has desirable attributes of both waxes. Similarly, these synthetic waxes and “wax blends” suffer from having additives that are not environmentally friendly and, over time, are harmful to automobile surfaces.

Some of the additives found in today's commercially available automobile waxes include inorganic solvents, clay, petroleum based additives, silicone extenders and many other inorganic materials. These are harmful to the vehicle's surface finish because they lead to the deterioration and break down of the physical characteristics of the paint over time. Finally, the additives found in commercially available automobile waxes are generally considered poisonous and as such pose a health risk to both the products user and the environment. There are no commercially available automobile waxes offered today that would advocate or even suggest consumption or ingestion by humans. Clearly, there is a need in the art for an organic wax that provides superior surface protection while reducing the risk posed to both the products user as well as the environment.

### SUMMARY OF THE INVENTION

The present invention provides a method and apparatus for making and applying a hand applied organic wax for protecting automobile surfaces. The method includes steps for creating the invention as well as the application of the invention to a surface of a vehicle. The unintuitive benefits of the present invention become immediately apparent only after using the invention. The invention creates a high gloss, hard protective coating without harming the surface finish or leaving a chalk like residue. The unique combination of safflower oil, vitamin E, porpolis extract and carnauba wax create a shine enhancer while providing the added benefit of hydrating the painted surface thus preventing the finish from discoloration, deterioration, fine line cracking, commonly referred to as “spider webbing”, and the dulling effects of acid rain.

The invention is created from four ingredients; carnauba wax, expeller pressed safflower oil, popolis extract and vitamin E. The proportional ratios of ingredients as well as the method used to create the composition are unique to the present invention. The present invention requires approximately 60% expeller pressed safflower oil, 30% carnauba wax, 5% porpolis extract and 5% vitamin E. Merely combining these ingredients will not create the present invention; rather a specific method described herein must be employed. The ingredients are first placed in a stainless steel pot or bowl. Heat is slowly applied to the outside of the bowl until a temperature range of approximately 185 to 200 degrees Fahrenheit (85 to 93 degrees Celcius) is reached. At this temperature range the ingredients begin to melt and combine together. As the ingredients begin to melt a slow stirring motion is employed to the mixture and continued until the mixture is homogenous. Homogenization occurs when the mixture clarifies into a completely transparent liquid. Once homogenized, the temperature is brought to 190 degrees Fahrenheit and liquid is slowly transferred into resale packaging containers. The containers are then placed in a vibration free environment and allowed to cool at an ambient temperature above 65 degrees Fahrenheit (18 degrees Celcius) for a minimum of 8 consecutive hours.

Application of the wax is also unique to the present invention. The wax is first placed in the hands and allowed to melt; melting is accomplished by natural body heat and/or in combination with a hand rubbing motion. Once the wax has melted and sufficiently coated the hands, the wax is applied by hand to the surface to be treated. The wax is applied horizontally with a back and forth rubbing motion and then leveled with a foam brush and/or cotton cloth. The waxed surface is then allowed to dry for 15 minutes after which it is buffed with a clean cloth to a lustrous shine. The waxed surface is allowed to cure for a period of about 24 hours after which the waxed surface is wiped with a clean cloth to remove any excess wax and further enhance the shine of the treated surface.

### BRIEF DESCRIPTION OF THE DRAWINGS

FIG. 1 is a flowchart depicting the steps of the method for creating one embodiment of the present invention, and

FIG. 2 is a flowchart depicting the steps of the method for implementing one embodiment of the present invention on a surface to be protected.

### DETAILED DESCRIPTION

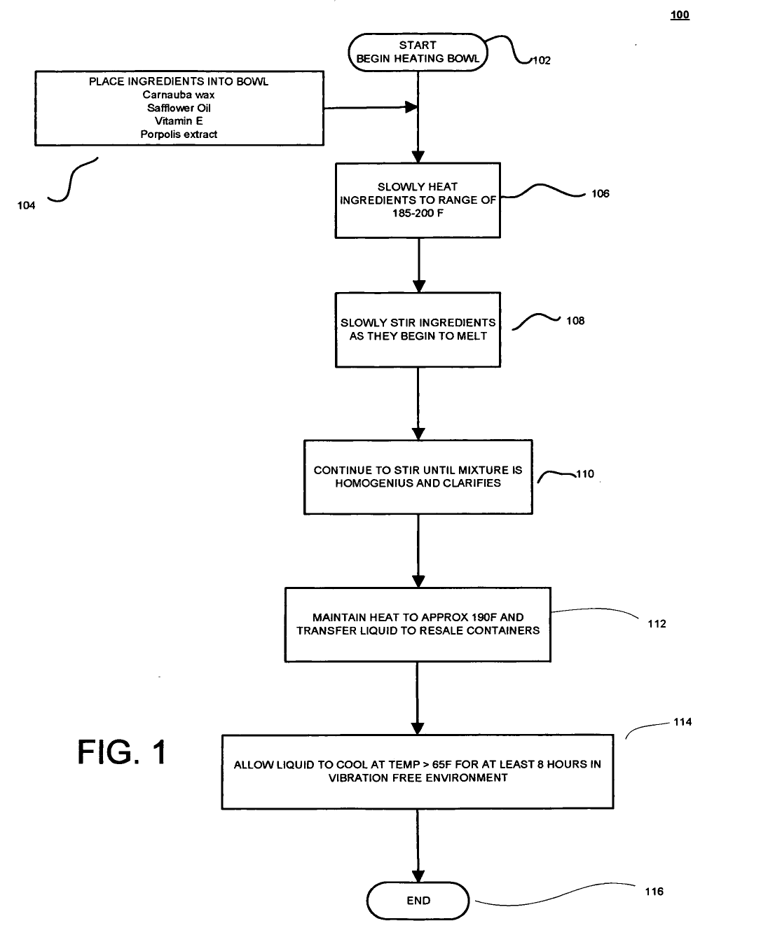

The present invention is created from the process as shown in FIG. 1 and designated generally by the reference numeral 100. Beginning with step 102, a stainless steel bowl or equivalent is heated to a temperature of between 185 and 200 degrees Fahrenheit. A variety of methods and techniques may be employed to raise the temperature of the bowl to the required temperature. These methods and techniques are well known to those skilled in the art and although no one means is required to heat the stainless steel bowl it should be noted that it is more desirable to use a means that evenly raises the temperature of the bowl. By evenly raising the temperature of the bowl it is less likely that the ingredients of the present invention will overheat and burn. Methods for evenly raising the temperature of a bowl are well known to those skilled in the art and include, but are not limited to; water bath heating, convection, contact coil radiation, disperse field microwave, forced air heat, induced heated magnetic impeller, etc.

As the stainless steel bowl nears its required temperature range of between 185 and 200 degrees Fahrenheit (85 to 93 degrees Celcius) the ingredients of the present invention are introduced into the bowl in step 104. It is important to place the ingredients into the stainless steel bowl before the bowl reaches the specified temperature range in order to prevent the ingredients from burning. Step 104 places all of the ingredients of present invention together. The ingredients of the present invention are carnauba wax, safflower oil, vitamin E and porpolis extract. It should be noted that the ratio of ingredients of the present invention are listed by weight and not volume and that all amounts are approximations. Approximately 60% of the composition is expeller pressed safflower oil while 30% is carnauba wax followed by 5% porpolis extract and 5% vitamin E. While carnauba wax is commonly available in the form of flakes and pellets those skilled in the art will recognize that carnauba wax in almost any form can be used in the present invention.

The formula of the present invention was not intuitive and actually teaches away from the conventional wisdom in the art. Almost all manufacturers of automobile wax rely on additives such as clay, petroleum byproducts and silicone extenders. It is commonly believed that these additives are necessary to produce a deep shine in the vehicle's finish. The present invention proves that these artificial additives are not necessary. Instead, the present invention employs safflower oil, porpolis extract and vitamin E, all natural ingredients, to produce an extremely deep natural shine not found in conventional automotive wax products. Additionally, the inventions organic feature holds many benefits, one of which is that the invention is completely nontoxic. If a person, adult or child, should ingest (i.e. eat) the present invention, no harm will occur to that individual. This is a unique claim as there are no other known manufactures of waxes that produce a completely non-toxic product. Similarly, the product benefits the environment because it does not contaminate soil or ground water and biodegrades quickly and harmlessly.

The ingredients of the present invention are placed in the bowl are slowly brought up to the desired temperature range in Step 106. Slowly increasing the heat ensures that the ingredients will melt without burning. As the ingredients begin to melt a stirring motion is introduced in step 108. The stirring motion should be slow, continuous and steady. The purpose of stirring is to thoroughly mix the heated liquefied ingredients into a homogeneous mixture as well as to prevent the mixture from burning. Stirring should be done slowly to avoid introducing air into the mixture, similarly whipping should be avoided in order to prevent emulsification and frothing of the mixture.

The mixture is continuously stirred until it becomes homogeneous as depicted in step 108. As the mixture becomes homogeneous it begins to clarify and become transparent. The complete clarification of the mixture is a signal that mixture is fully homogenized. At this stage in the process the temperature of the mixture is checked and raised or lowered until it reaches approximately 190 degrees Fahrenheit as depicted in step 112. At this stage the mixture is ready to be transferred into its retail packaging containers. At a temperature of approximately 190 degrees Fahrenheit (87 degrees Celcius) the mixture is slowly transferred to avoid the introduction of air bubbles into the retail containers. Those skilled in the art will recognize that many transfer methods may be used to transport the heated liquid into resale containers. After the liquefied mixture has been placed in its resale containers it is allowed to cool in a vibration free environment at a temperature above 65 (18 degrees Celcius) degrees Fahrenheit for at least 8 consecutive hours as depicted in step 114. As the liquid cools it slowly begins to solidify and cure.

By allowing the mixture to cool and cure in the vibration free environment cracking is prevented within the solid product. An important feature of the method of creating the present invention is that the cooling is accomplished naturally without the use of an accelerant such as ice or liquid nitrogen. By allowing the mixture to slowly cool at ambient room temperature, not less than 65 degrees Fahrenheit (18 degrees Celcius), the invention can properly cure. During curing the molecular structure of the wax is ordered in such a way that the solid product takes on the most desirable characteristics of the individual ingredients. Some of these characteristics include a lowered melting point, buttery smooth consistency, and the ability, when properly applied to a painted automobile surface, to produce a deep durable luster and shine.

The process depicted by FIG. 1 ends with step 116 where the final product is inspected, sealed and shipped to various and sundry retailers.

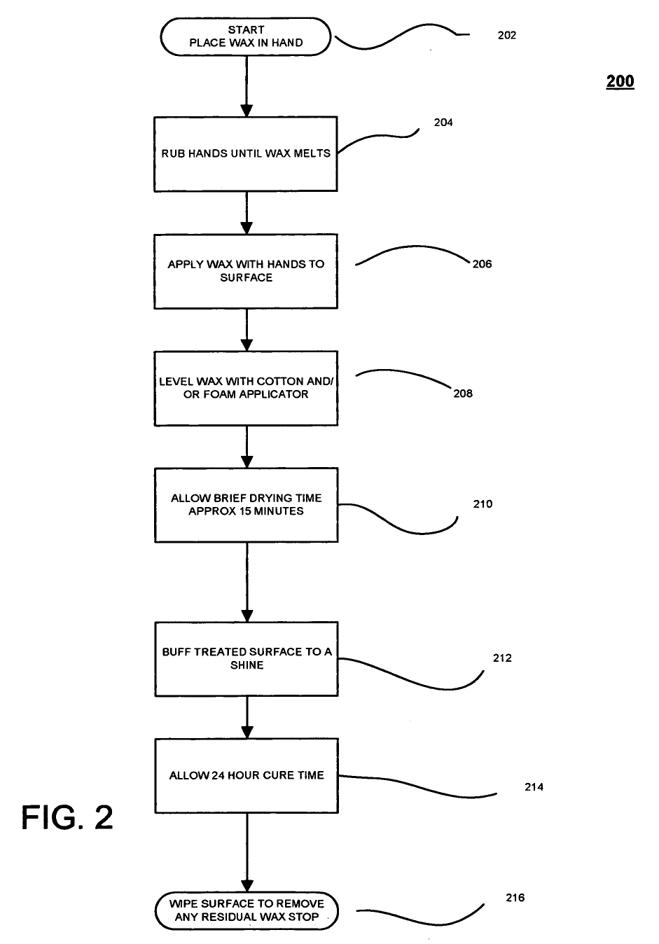

Application of the present invention is depicted in FIG. 2 and the entire process is denoted as 200. The process starts by placing an amount of wax in the hand as depicted by step 202. The precise amount of wax to be placed in the hand will varies from individual to individual but a small amount no larger than the size of a dime is generally recommended.

Next the wax is rubbed between the hands until the heat from the hands and the rubbing motions have completely melted the wax, as depicted in step 204. The hands, which are now coated with the wax, are then rubbed on the surface of the vehicle in order to transfer the wax to the vehicle in a liquid or semisolid state, as described in step 206. The wax is applied with a back and forth rubbing motion to one section of the vehicle at a time. The inventor contemplates that for best results the present invention be applied to the vehicle finish at a temperature above 65 degrees Fahrenheit (18 degrees Celcius) in the absence of direct sunlight.

After the vehicle surface has been sufficiently coated the wax, the wax is leveled with a cotton and/or foam applicator, step 208. Leveling the wax creates a smooth surface on the vehicles finish which reflects light evenly and aids in creating an enhanced luster and shine. After leveling the wax, the wax is allowed to dry for approximately 15 minutes in step 210. Drying allows the wax to penetrate and solidify on the surface of the vehicles finish. After 15 minutes the treated surface is buffed to a high gloss shine as depicted in step 212. Buffing is accomplished with clean commonly available buffing materials including but not limited to micro fiber cloth and the like.

A period of 24 hours is required to allow the wax to cure on the vehicle surface, as depicted in step 214. This 24 period is critical because the wax will continue to dry and furthermore it will penetrate deeper into the vehicle finish allowing the finish to become moisturized and hydrated. This moisturizing and hydration produces a high gloss on the exterior finish without harming the vehicles surface.

Step 216 depicts the final step in the application process 200; after 24 hours the vehicles surface is wiped down to remove any trace residual wax. This wiping also acts to enhance the shine and luster imparted by the present invention.

The forgoing detailed description is to be understood as being in every respect illustrative and exemplary, but not restrictive, and the scope of the invention disclosed herein is not to be determined from the detailed description but rather from the claims as interpreted according to the full breadth permitted by the patent laws. It is to be understood that the embodiment shown and described herein are only illustrative of the principals of the present invention. Those skilled in the art could implement various other feature combinations without departing from the scope and sprit of the invention.

What is claimed is:

1. An organic wax for protecting surface finishes comprising:
from about 2% to about 5% vitamin E;
from about 2% to about 5% porpolis extract;
from about 25% to about 30% carnuba wax; and
from about 55% to about 60% safflower oil.

2. The organic wax of claim 1 wherein the safflower oil is expeller pressed.

3. The process for preparing the organic wax of claim 1 comprising the following steps:
(a) placing carnauba wax, safflower oil, porpolis extract and vitamin E in a stainless steel bowl;
(b) heating the container slowly to a temperature between 185 and 200 degrees Fahrenheit (85 to 93 degrees Celcius);
(c) melting the contents within the bowl;
(d) stirring the melted contents slowly until a clarified liquid is formed;
(e) dispensing said clarified liquid into small containers; and
(f) cooling said liquid at ambient room temperature in a vibration free environment for a minimum of 8 hours.

4. The process of claim 3 wherein the ambient room temperature is above 65 degrees Fahrenheit (18 degrees Celcius).

5. A method of protecting surface finishes comprising the following steps:
placing a small amount of wax in the palm of one hand;
rubbing the palms of the hands together in order to melt the wax;
applying the wax horizontally to the surface to be protected;
allowing wax to dry;
buffing the waxed surface to lustrous shine;
allowing the wax to cure; and
wiping the surface.

6. The method of claim 5 wherein the ambient temperature for applying the wax is above 65 degrees Fahrenheit (18 degrees Celcius).

7. The method of claim 5 wherein the step of applying the wax horizontally to the surface further comprises the step working one section at a time.

8. The method of claim 5 wherein the wax is allowed to dry for 15 minutes before buffing.

9. The method of claim 5 wherein the wax is allowed to cure for 24 hours before wiping the surface.

10. The method of claim 5 wherein the surface is buffed with a clean micro fiber cloth.

11. The method of claim 5 wherein the wax is applied with a cotton cloth or foam applicator.
